(19) United States
(12) Patent Application Publication
(10) Pub. No.: US 2015/0333584 A1
(43) Pub. Date: Nov. 19, 2015

(54) HIGH SPEED BRUSHLESS DC ELECTRIC MACHINE

(71) Applicant: Calnetix Technologies, LLC, Cerritos, CA (US)

(72) Inventor: Patrick McMullen, Villa Park, CA (US)

(73) Assignee: Calnetix Technologies, LLC, Cerritos, CA (US)

(21) Appl. No.: 14/278,988

(22) Filed: May 15, 2014

(51) Int. Cl. H02K 1/27; H02K 1/28

(52) U.S. Cl. CPC H02K 1/278; H02K 1/28

(57) ABSTRACT

Certain aspects encompass a brushless DC electric machine that has a DC stator having field windings. The DC electric machine additionally has a DC rotor. The DC rotor has a rotor core and a plurality of permanent magnets arranged around the rotor core. The permanent magnets are shaped and have a gap between each adjacent permanent magnet to produce a trapezoidal back EMF in the field windings. A non-magnetic material resides in the gaps and bridges each adjacent permanent magnet. A non-magnetic sleeve is provided around the permanent magnets and the non-magnetic filler material retaining the permanent magnets to the core.

### BACKGROUND

A conventional brushless direct current (DC) electric machine has a permanent magnet rotor, i.e. a rotor core with a plurality of permanent magnets fixed to the core. Those that are able to achieve high speeds, however, are very small machines, both in power and physical size, because of limitations in the manner of fixing the magnets to the rotor core. Typically, the permanent magnets are merely bonded to the rotor core. As the power and physical size of the machine increases, so does the size of the permanent magnets. Larger permanent magnets exert greater forces on the bond between the permanent magnet and the rotor core as the rotor spins. The size of the permanent magnets limit the rotational speed, as the ultimate strength of the bond is reached. Magnet retention is the result of a combination of magnet bonding and magnet attraction force to the rotor core.

More sophisticated containment methods are difficult due to the shape of the permanent magnets and space between magnets needed to achieve the trapezoidal electromotive (EMF) waveforms used in DC electric machines and increases in rotor/stator air gap affecting machine size and efficiency.

### DESCRIPTION OF DRAWINGS

FIG. 1 is a half, side cross-sectional view of an example brushless DC electric machine system in accordance with the concepts herein.

FIG. 2. is a half, end cross-sectional view of an example brushless DC electric machine in accordance with the concepts herein.

FIG. 3 is a schematic of a trapezoidal EMF waveform.

Like reference symbols in the various drawings indicate like elements.

### DETAILED DESCRIPTION

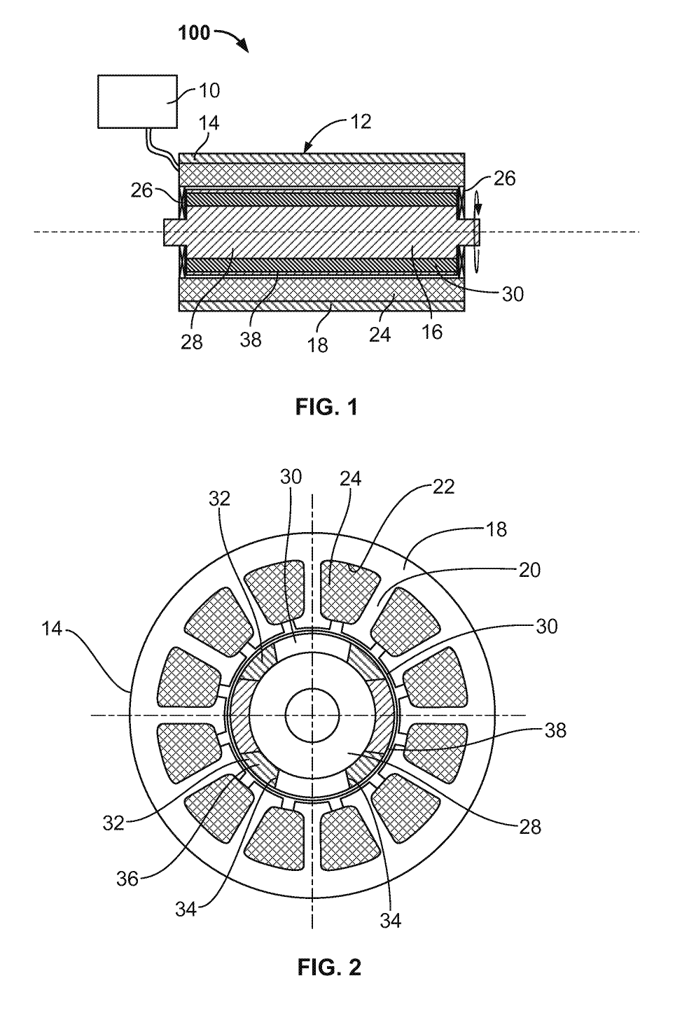

FIG. 1 is a half, side cross-sectional view of an example brushless DC electric machine system 100 in accordance with the concepts herein. The system 100 includes a brushless DC electric machine 12 and a DC power electronics module 10. The brushless DC electric machine 12 includes a DC stator 14 and a permanent magnet rotor 16. The rotor 16 can be coupled to a load that is driven by the electric machine 12. The DC electric machine 12, in certain instances, can be characterized as a high power, high speed machine.

The DC stator 14 is generally cylindrical, defining an interior cavity through its center that internally receives the permanent magnet rotor 16. As best seen in FIG. 2, the stator 14 has a stator core 18 with a plurality of radially inwardly extending ribs or teeth 20 running the axial length of the stator core 18. Adjacent teeth 20 define axial slots 22 therebetween. In certain instances, the stator core 18 is constructed of a plurality of axially stacked conductive laminations bonded together with a resin and/or other polymer adhesive, or welded, or other method. In certain instances, the laminations are electrical steel. The stator core 18 carries one or more field windings 24 distributed circumferentially around the stator core 18 to define alternating pairs of opposing coils. Each coil is coiled around a single tooth 20, residing in the slots 22 on each side of the tooth 20. Because the coils encircle a single tooth, they are amenable to mass manufacture (and reduced costs) with common automated machine winding techniques. Multiple coils are interconnected to make a winding 24. In certain instances, the coils are interconnected to facilitate outputting a trapezoidal EMF when energized. In an instance where the DC electric machine 12 is a three phase machine, it has three sets of windings 24. The DC electric machine 12 can have fewer or more phases. The windings 24 are connected to the power electronics.

The DC rotor 16 is supported (by bearings 26 and/or otherwise) to rotate in the interior cavity of the DC stator 14. The rotor 16 has a rotor core 28 with a plurality of permanent magnets 30 fixed around the perimeter of the core 28. The rotor core 28 can be formed from a solid, single piece of material (e.g., magentic metal) or another construction. In certain instances, the permanent magnets 30 are rare Earth magnets. The polarity of the magnets 30 is oriented to define alternating opposing pole pairs. In certain instances, the number of pole pairs of the rotor 16 is fewer than the number of coil pairs of the windings 24. FIG. 2 shows two pole pairs on the rotor 16 and six coil pairs of the windings 24 (two for each phase if operated as three phase).

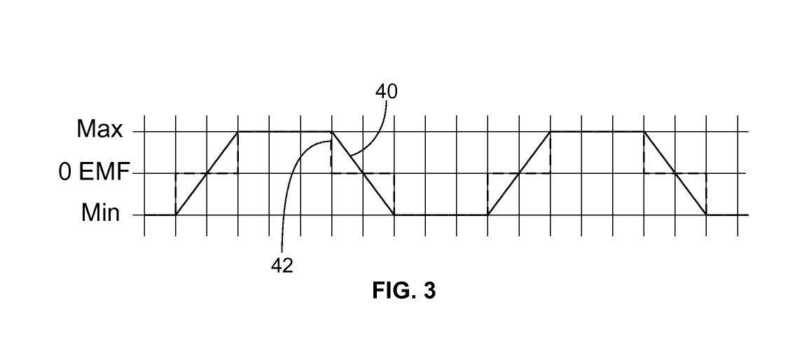

The permanent magnets 30 are adapted to produce a field that generates a trapezoidal waveform (as opposed to sinusoidal) back EMF in the field windings 24 of the DC stator 14. FIG. 3 shows an example trapezoidal waveform 40. In certain instances, the trapezoidal back EMF waveform 40 can be approximated by a series of square or nearly square waveforms 42. Referring back to FIG. 2, the magnets 30 are circumferentially spaced apart around the rotor core 28 and form large gaps 32 between adjacent magnets 30. The large gaps 32 facilitate a steep drop-off in the magnetic field produced by the permanent magnets 30, thereby promoting the trapezoidal (non-sinusoidal) shape of the back EMF. Additionally, in certain instances, to facilitate the steep drop-offs, each magnet 30 has parallel circumferential end side surfaces 34, and the resulting gap 32 between adjacent magnets 30 increases with increasing radius. The gaps 32 and shape of the magnets 30 can be adapted to reduce or minimize harmonics generated in the rotor 14 during operation.

The gaps 32 between adjacent magnets 30 contain a non-magnetic, and in certain instances, non-metallic, filler material 36. The non-magnetic filler material 36 bridges adjacent magnets 30 to form a continuous circumferential surface 38 around the entire perimeter of the rotor 16. By being non-magnetic, the material does not interfere with the magnetic fields produced by the magnets 30. The non-magnetic filler material 36 can take many forms. In certain instances, the non-magnetic filler material 36 is a material that can exist in liquid or paste form at room temperature and then harden, for example, in response to contact with another material (e.g., a catalyst), exposure to heat and/or over time. Such material is applied or filled into the gaps 32 and then allowed to harden. If applied in this manner, the non-magnetic filler material 36 can be applied so that it entirely fills the gaps 32. In certain instances, the permanent magnets 30 can have been bonded, affixed with fasteners, and/or held with clamps to the rotor core 28 prior to applying the non-magnetic filler material 36. Some examples of hardening materials include stainless steel based or other non-magnetic metal based metal matrix composite, carbon reinforced plastic, aramid reinforced plastic, fiberglass, ceramic and/or other materials.

After the non-magnetic filler material 36 is installed into the gaps 32, the non-magnetic filler material 36 may be shaped (e.g., molded) or machined to provide or improve the continuous surface of the magnets 30 and non-magnetic filler material 36 with a smooth, constant radius surface around its entire perimeter. In other words, the exterior surface of the magnets 30 and non-magnetic filler material 36 is cylindrical. In certain instances, the machining process can be a grinding process that grinds both the non-magnetic filler material 36 in the gaps 32 and the permanent magnets 30 to a smooth, uniform radius around the entire perimeter. In certain instances the filler does not require any processing once hardened, eg. a high quality mold process.

Finally, a non-magnetic, and in certain instances, non-metallic sleeve 38 can be placed around the permanent magnets 30 and the non-magnetic filler material 36 to retain the permanent magnets 30 to the rotor core 28. In certain instances, the permanent magnets 30 are retained to the rotor core 28 only by the non-magnetic sleeve 38. In such an instance, the non-magnetic sleeve 38 is sized and its material properties are such that the sleeve 38 can retain the magnets 30 at all operating speeds of the DC electric machine 12. In other instances, the bonding or other fixing mentioned above can contribute to retaining the permanent magnets 30 to the rotor core 28. The sleeve 38 can be in tension, configured to produce a specified compressive stress on the permanent magnets 30 and non-magnetic filler material 36, such that as the rotor 16 rotates, the force from the compressive stress is subtractive from the centrifugal force of the rotating magnets 30.

In certain instances, the non-magnetic sleeve 38 is a fiber reinforced plastic. For example, the sleeve 38 can be laid up in one or more layers around the permanent magnets 30 and non-magnetic filler material 36. Some examples of materials for the sleeve 38 include carbon fiber composite, aramid fiber composite, fiberglass and/or other materials.

The sleeve 38 is preferably very thin, so as to minimize the non-magnetic space (i.e., “air gap”) between the windings 24 and the permanent magnets 30. Without the non-magnetic filler material 36, and due to the tension in the sleeve 38, the portion of the sleeve 38 spanning the gaps 32 between permanent magnets 30 would collapse to span the gaps 32 as a chord. Such a configuration would form a stress riser on the end side surfaces 34 of the magnets 30, with the potential to damage the magnets 30 or the sleeve 38. The non-magnetic filler material 36, however, supports the sleeve 38 between the permanent magnets 30 to reduce this stress riser. In certain instances, the non-magnetic filler material 36 supports the sleeve 38 into a cylindrical shape, eliminating its tendency to form a chordal shape between the magnets 30. To facilitate supporting the sleeve 38, the non-magnetic filler material 36 is selected and constructed in a manner to have a compressive strength that can counter the compressive stress applied by the sleeve 38 without failure of the filler material 36 and with strain that prevents overstress on the end side surfaces 34 of the permanent magnets 30. Additionally, the non-magnetic filler material 36 can contribute to supporting the permanent magnets 30 circumferentially on the rotor core 28, maintaining the gaps 32 precise to maintain the precision of the trapezoidal back EMF waveform. A uniform cylindrical shape also has the benefit of enhanced efficiency by its reduction in windage drag losses (aerodynamic drag) over that of a lobed or distint poles on the rotor.

In operation, the DC power electronics module 10 receives AC or DC electricity and performs switching to produce a trapezoidal driving EMF waveform in the windings 24. The trapezoidal driving waveform in the windings 24 corresponds to the trapezoidal EMF produced by the rotor 16. The current supplied by the power electronics module 10 drives the rotor 16 to rotate. In certain instances, the DC power electronics module 10 and DC electric machine 12 are adapted to operate on 25 kW (kilowatts) of electricity and drive the rotor at speeds of 25,000 rpm (rotations per minute) or greater. The switching frequency of the power electronics module 10 to produce the square driving waveform can be much lower than that necessary to produce a sinusoidal driving waveform. In an instance where the system 100 is three phase, the power electronics module 10 can use a six-step commutation method to drive the motor 12. The lower switching frequency enables using less complex, and less expensive, power electronics than necessary for sinusoidal driving waveforms. The simpler switching and waveform also facilitates driving electric machines 12 that are a far distance from the power electronics module 10. For example, in one instance the electric machine 12 is a component of a in-well compressor or pump, where the power electronics module 10 resides outside of the well and/or at the surface.

In view of the above, certain aspects encompass a brushless DC electric machine that has a DC stator having field windings. The DC electric machine additionally has a DC rotor. The DC rotor has a rotor core and a plurality of permanent magnets arranged around the rotor core. The permanent magnets are shaped and have a gap between each adjacent permanent magnet to produce a trapezoidal back EMF in the field windings. A non-magnetic material resides in the gaps and bridges each adjacent permanent magnet. A non-magnetic sleeve is provided around the permanent magnets and the non-magnetic filler material retaining the permanent magnets to the core.

Certain aspects encompass a method where a plurality of permanent magnets of the DC rotor are supported to the rotor core with a non-magnetic sleeve. The non-magnetic sleeve is supported in gaps between the permanent magnets with a non-magnetic filler material bridging the gaps. The gaps are provided and the permanent magnets are shaped to induce a trapezoidal back EMF in the field windings of the DC stator.

Certain aspects encompass a brushless DC electric machine rotor. The rotor has a rotor core and a plurality of spaced apart permanent magnets carried by the rotor core. The plurality of permanent magnets are adapted to produce a trapezoidal back EMF in a DC stator field winding. Non-magnetic filler material spans the spaces between adjacent permanent magnets. A non-magnetic sleeve surrounds the permanent magnets and the non-magnetic filler material and supports the permanent magnets to the rotor core.

The aspects above include some, none or all of the following features. In certain instances, the permanent magnets and the non-magnetic filler material define a continuous circumferential surface. The continuous circumferential surface can have a uniform radius around its entire perimeter. The continuous circumferential surface can be smooth around its entire perimeter. In certain instances, the non-magnetic filler material is nonmetallic. In certain instances, each magnet has end sides that are parallel. In certain instances the non-magnetic sleeve includes a fiber reinforced plastic including at least one of carbon fiber, aramid fiber or fiberglass. In certain instances, the permanent magnets are retained to the rotor core only by the non-magnetic sleeve. The permanent magnets can be additionally bonded to the rotor core. The non-magnetic sleeve applies a specified compressive stress to the magnets and the non-magnetic filler material, and the non-magnetic filler material supports the sleeve against collapse in a region spanning the gaps between magnets. In certain instances the DC stator and DC rotor are adapted to operate on 25 kW of electricity or more at speeds of 25,000 RPM or greater.

A number of embodiments have been described. Nevertheless, it will be understood that various modifications may be made. Accordingly, other embodiments are within the scope of the following claims.

What is claimed is:

1. A brushless DC electric machine, comprising:
a DC stator having field windings;
a DC rotor comprising:
a rotor core;
a plurality of permanent magnets arranged around the rotor core shaped and having a gap between each adjacent permanent magnet to produce a trapezoidal back electromotive force in the field winding;
a non-magnetic filler material in the gaps and bridging each adjacent permanent magnet; and
a non-magnetic sleeve around the permanent magnets and non-magnetic filler material retaining the permanent magnets to the rotor core.

2. The brushless DC electric machine of claim 1, where the permanent magnets and the non-magnetic filler material define a continuous circumferential surface.

3. The brushless DC electric machine of claim 2, where continuous circumferential surface has a uniform radius around its entire perimeter.

4. The brushless DC electric machine of claim 2, where the continuous circumferential surface is smooth around its entire perimeter.

5. The brushless DC electric machine of claim 1, where the non-magnetic filler material is non-metallic.

6. The brushless DC electric machine of claim 1, where each magnet has end sides that are parallel.

7. The brushless DC electric machine of claim 1, where the non-magnetic sleeve comprises a fiber reinforced plastic comprising at least one of carbon fiber, aramid fiber or fiberglass.

8. The brushless DC electric machine of claim 1, where the permanent magnets are retained to the rotor core only by the non-magnetic sleeve.

9. The brushless DC electric machine of claim 1, where the permanent magnets are bonded to the rotor core.

10. The brushless DC electric machine of claim 1, where the non-magnetic sleeve applies a specified compressive stress to the magnets and the non-magnetic filler material supports the sleeve against collapse in regions spanning the gaps.

11. The brushless DC electric machine of claim 1, where the DC stator and DC rotor are adapted to operate on 25 kW of electricity or more at speeds of 25,000 rpm or greater.

12. A method, comprising:
supporting a plurality of permanent magnets of a DC rotor to a rotor core with a non-magnetic sleeve; and
supporting the non-magnetic sleeve in gaps between the permanent magnets with a non-magnetic filler material bridging the gaps, the gaps and the permanent magnets shaped to induce a trapezoidal back electromotive force in field windings of a DC stator.

13. The method of claim 12, where supporting the plurality of permanent magnets with the non-magnetic sleeve comprises applying a specified compressive stress to the permanent magnets with the non-magnetic sleeve; and
where supporting the non-magnetic sleeve in gaps between the permanent magnets with the non-magnetic filler material, comprises supporting the non-magnetic sleeve against collapse.

14. The method of claim 12, comprising applying a hardening non-magnetic filler material into the gaps in a non-hardened state and allowing the non-magnetic filler material to harden.

15. The method of claim 12, comprising machining an outer diameter of the non-magnetic filler material to have a uniform radius equal to a uniform radius of the permanent magnets; and
installing the non-magnetic sleeve around the permanent magnets and non-magnetic filler material.

16. The method of claim 12, where machining an outer diameter of the non-magnetic filler material comprises also machining the permanent magnets.

17. A brushless DC electric machine rotor, comprising:
a rotor core;
a plurality of spaced apart permanent magnets carried by the rotor core, the plurality of permanent magnets adapted to produce a trapezoidal back electromotive force in a DC stator field winding;
a non-magnetic filler material spanning spaces between adjacent permanent magnets; and
a non-magnetic sleeve surrounding the permanent magnets and non-magnetic filler material and supporting the permanent magnets to the rotor core.

18. The rotor of claim 17, where the non-magnetic sleeve applies a specified compressive stress to the permanent magnets and the non-magnetic filler material supports the sleeve against collapse in regions spanning the spaces between adjacent permanent magnets.

19. The rotor of claim 17, where the non-magnetic filler material and permanent magnets define a smooth, continuous circumferential surface having a uniform radius around its entire perimeter.

20. The rotor of claim 17, where the non-magnetic sleeve comprises at least one of carbon fiber, aramid, or fiberglass.
